(19) United States
(12) Patent Application Publication
(10) Pub. No.: US 2010/0303150 A1
(43) Pub. Date: Dec. 2, 2010

(54) SYSTEM AND METHOD FOR CARTOON COMPRESSION

(76) Inventors: Ping-Kang Hsiung, Pacific Palisades, CA (US); Chung Chieh Kuo, Arcadia, CA (US); Sheng Yang, Wenshan (TW)

Correspondence Address: CHRISTIE, PARKER & HALE, LLP, PO BOX 7068, PASADENA, CA, 91109-7068, US

(21) Appl. No.: 12/376,965

(22) PCT Filed: Aug. 8, 2007
(86) PCT No.: PCT/US07/17718

§ 371 Date: Aug. 17, 2010

Related U.S. Application Data
(60) Provisional application No. 60/836,467, filed on Aug. 8, 2006.
(60) Provisional application No. 60/843,266, filed on Sep. 7, 2006.

(51) Int. Cl. H04N 7/26

(52) U.S. Cl. 375/240.08; 375/E07.2

(57) ABSTRACT

A system, specialized for encoding video of animated or cartoon content, encodes a video sequence. The system includes a background analyzer that removes moving objects from a series of video frames and generates a background definition for a static background used in a plurality of sequential video frames, a color clusterer that analyzes the colors contained in a video stream and creates a major color list of colors occurring in the video stream, an object identifier that identifies one or more objects that are constant within a series of video frames except for their position and rotational orientation within the series of video frames, and a hybrid encoder that encodes backgrounds and objects derived from a video sequence according to one of a plurality of encoding techniques depending on the compression achieved by each of the plurality of encoding techniques.

### CROSS-REFERENCE TO RELATED APPLICATION(S)

This application is a National Phase patent application based on PCT Application No. PCT/US2007/017718, filed Aug. 8, 2007, which claims priority of U.S. Provisional Application Nos. 60/836,467, filed Aug. 8, 2006 and U.S. Provisional Application No. 60/843,266, filed Sep. 7, 2006, the disclosures of which are incorporated fully herein by reference.

### BACKGROUND OF THE INVENTION

Various video compression techniques are known in the art, such as MPEG-3, MPEG-4, H.264. Generally, these video compression techniques are good at compressing “live action” content, such as content shot with a conventional film or video camera. There is a need for a compression technique that takes into account unique features of animated, and particularly cartoon based video.

### SUMMARY OF THE INVENTION

Animation, and particularly cartoon animation, has many characteristics that set it apart from “natural” or “live action” film or video. The present invention takes advantage of some of the characteristics and provides more flexible compression techniques to improve the coding gain and/or reduce the computational complexity in decoding. Some of the features of cartoons are:

The camera movement is very simple, usually camera zooming and panning. In most cases, the camera remains still for one scene.

There are fewer number of colors or shades of colors.

The textural pattern is very simple. For example, one solid area is usually rendered with one single color.

The boundaries of objects are very clear, so that the objects can be easily separated from the background.

A system according to the invention, specialized for encoding video of animated or cartoon content, encodes a video sequence. The system includes a background analyzer that removes moving objects from a series of video frames and generates a background definition for a static background used in a plurality of sequential video frames, a color clusterer that analyzes the colors contained in a video stream and creates a major color list of colors occurring in the video stream, an object identifier that identifies one or more objects that are constant within a series of video frames except for their position and rotational orientation within the series of video frames, and a hybrid encoder that encodes backgrounds and objects derived from a video sequence according to one of a plurality of encoding techniques depending on the compression achieved by each of the plurality of encoding techniques.

### BRIEF DESCRIPTION OF THE DRAWINGS

FIG. 1 is a block diagram of the system architecture of an exemplary embodiment of the invention.

FIG. 2A is an original cartoon frame before Intra-processing filtering.

FIG. 2B is the frame shown in FIG. 2A after filtering by the Intra-processing filter according to an embodiment of the invention.

FIG. 2C is the negative difference between the frames shown in FIGS. 2A and 2B.

FIGS. 3A and 3B show two consecutive frames in an example cartoon.

FIG. 3C shows the difference between the frames shown in FIGS. 3A and 3B.

FIG. 3D shows the frame shown in FIG. 3C after sharpening.

FIG. 3E shows a filtered image of the frame shown in FIG. 3C after sharpening.

FIG. 4 is a histogram of the difference frame shown in FIG. 3C.

FIG. 5 is a video frame that exhibits a 3:2 pulldown artifact.

FIG. 6 is a block diagram of an embodiment of a modified encoder.

FIG. 7 is a graph showing the empirical results of measuring for all possible inter-frame luminance differences.

### DETAILED DESCRIPTION OF THE INVENTION

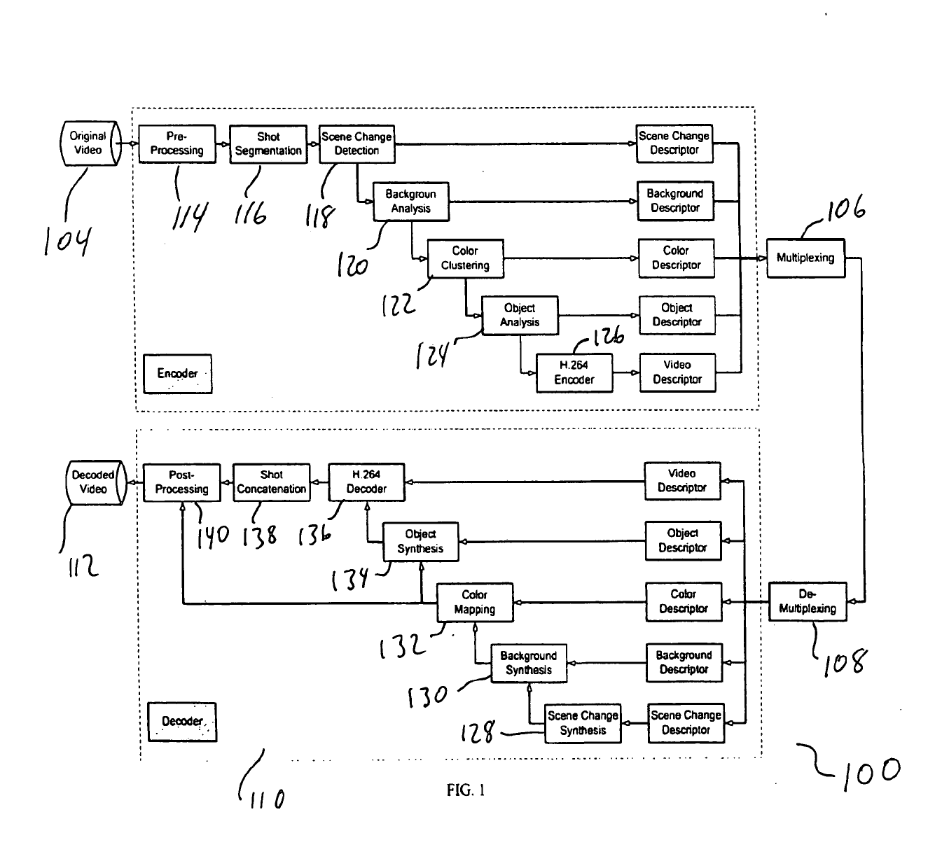

A block diagram of the system architecture of an exemplary embodiment of the invention is shown in FIG. 1. The system 100 of FIG. 1 includes an encoder 102 that receives video 104 and produces an output to multiplexor 106. The output of multiplexor 106 is input into demultiplexor 108 which sends its output to decoder 110. Decoder 110 then outputs decoded video 112. In many embodiments, the encoder 102 and decoder 110 are implemented using a programmed general purpose computer. In other embodiments, the encoder 102 and decoder 110 are each implemented in one or more special function hardware units. In yet other embodiments, encoder 102 and decoder 110 each include a programmed general purpose computer that performs some of the functions of the encoder or decoder and one or more special function hardware units that perform other functions of the encoder or decoder. For example, encoder 102 may be implemented mostly on a programmed general purpose computer, but uses a dedicated H.264 encoder for performing H.264 encoding of specific portions of data, while decoder 110 may be implemented entirely using special function hardware units, such as an ASIC chip in a handheld video playback device.

Encoder 102 and decoder 110 are shown in FIG. 1 containing a number of blocks that represent a function or a device that performs a function. Each of the blocks, however, represent both a function performed and a corresponding hardware element that performs that function, regardless of whether the block is labeled as a function or as a hardware device.

Cartoon footage is often stored in Betacam format. Due to the lossy compression techniques used by Betacam devices, the decoded video sequence slightly differs from the original one. This can be deemed as a kind of noise. Although the noise does not deteriorate the visual quality, it requires more bits and decreases the compression ratio. Therefore, if the source being compressed is from Betacam storage, the noise must be first removed before actual encoding in pre-pre-processing 114. The noise can be classified into two categories: Intra-noise (noise within one frame) and Inter-noise (noise between two frames).

The purpose of intra pre-processing is to remove the noise within one frame, such as an I-frame. Such a frame is usually the first frame in a video shot or scene, since it can be used as a reference for the subsequent consecutive frames in that video shot or scene.

During the procedure of producing animation, one solid area is usually filled with one single color, for example, in one frame, the entire sky is a particular shade of blue. However, after conversion from Betacam or other video storage, there are usually tiny differences in these areas. The Pre-Processor shown in FIG. 1 includes an Intra-processing filter (not shown). The Intra-processing filter is designed to map the colors with similar values into one color, and hence remove the tiny disturbances due to the lossy storage.

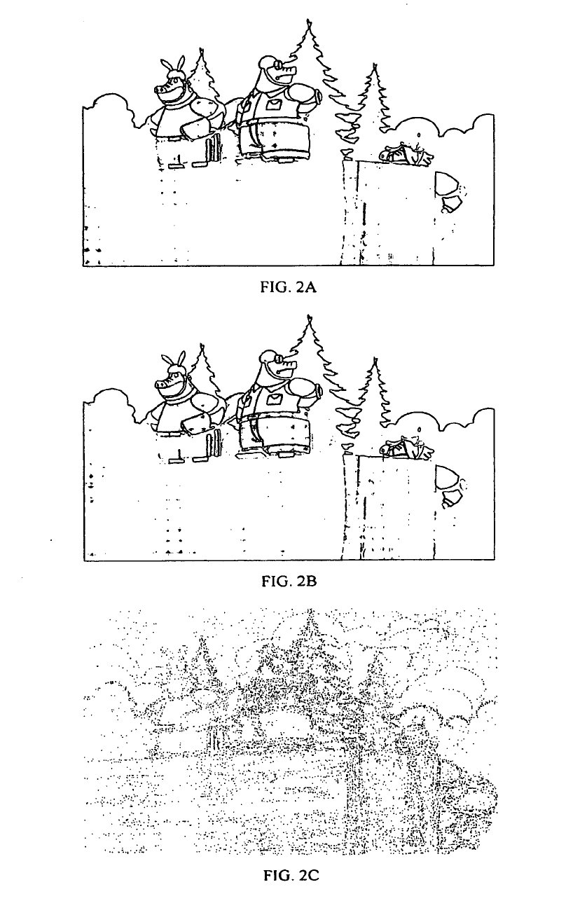

An example of the results of intra-noise and pre-processing is shown in FIGS. 2A-2D. FIG. 2A is an original cartoon frame before filtering. FIG. 2B is the frame from FIG. 2A after filtering by the Intra-processing filter according to an embodiment of the invention. FIG. 2C is the negative difference between 2A and 2B (black indicates difference), sharpened and the contrast increased so that the differences are more easily human perceptible.

The purpose of inter pre-processing is to remove the noise in P and B-frames, usually the other frames besides I-frames within a video shot. An I-frame is used as a reference to remove the noise in P and B-frames.

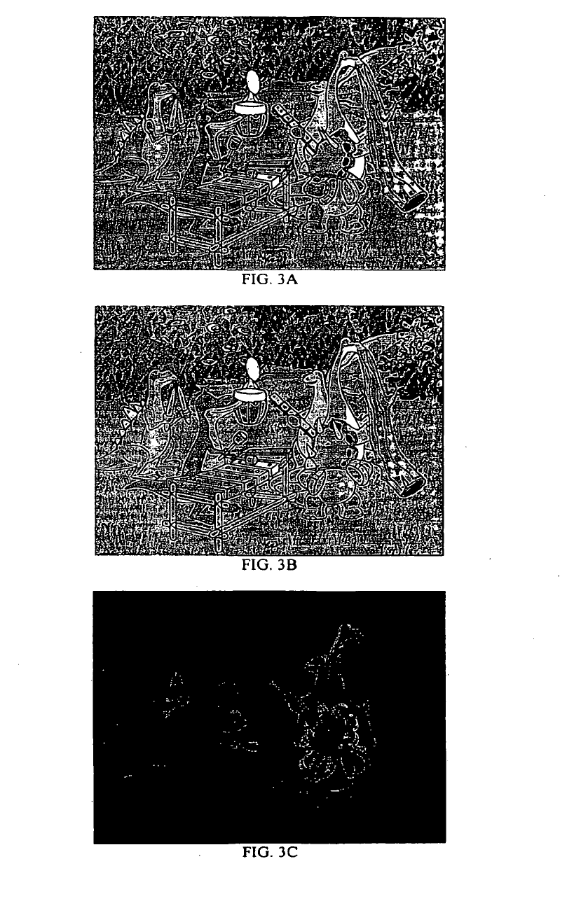

FIGS. 3A and 3B show two consecutive frames in an example cartoon. The difference between them is shown in FIG. 3C. After sharpening, the noise can be clearly seen from FIG. 3D.

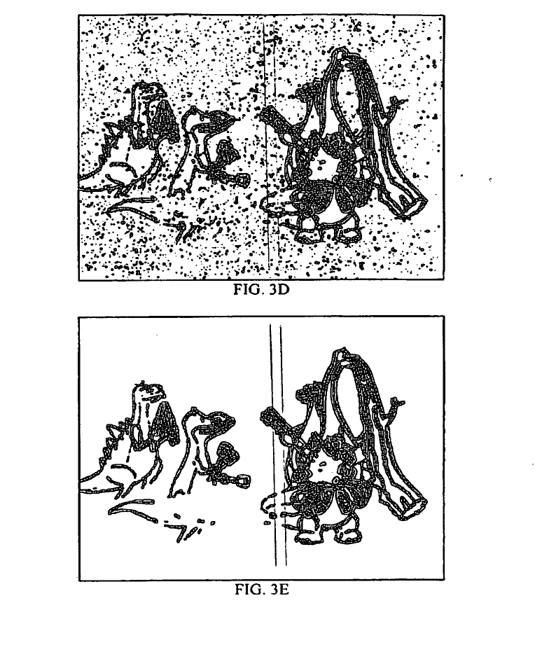

By analyzing the noise distribution, we found that the norm of noise is usually very small, which sets itself apart from real signal, as shown in FIG. 4. A threshold is carefully selected based on the histogram shown in FIG. 4 to remove the noise. The filtered image is shown in FIG. 3E. The filtered image of FIG. 3E, after sharpening, is shown in FIG. 3F.

Besides the above two artifacts, if the original cartoon sequences have been processed by 3:2 pulldown and then de-interlaced, there will be the third artifact: interlacing. 3:2 pulldown is utilized to convert 24 fps source (typically film) into 30 fps output (typically NTSC video) where each frame in the 30 fps output consists of 2 sequential, interlaced fields. In other words, the 30 fps output comprises 60 interlaced fields per second. In a such an output generated by 3:2 pulldown, the first frame from the source is used to generate 3 consecutive fields—the first two fields making up the first frame of the output with the last field making one half of the next frame. The second source frame is then used to generate the next 2 consecutive fields—the first field making up the second field of the second output frame and the second field making up the first field of the third output frame. With The third source frame we return to using it to generate 3 consecutive fields—the first field making up the second half of the third output frame and the second and third fields making up the fourth output frame. Note that this third output frame now has one field derived from the second source frame and one field derived from the third source field. This is not a problem as long as the output remains interlaced. Continuing with conversion, we return to the 3:2:3:2 cycle (hence 3:2 pulldown) and the fourth source frame is used to generate 2 output fields—both now used for the fifth frame of the output. Using this process repeatedly, every 4 frames of source are converted to 5 frames (10 fields) of output—a ratio of 24:30—achieving the conversion from 24 fps to 30 fps (60 fields per second, interlaced).

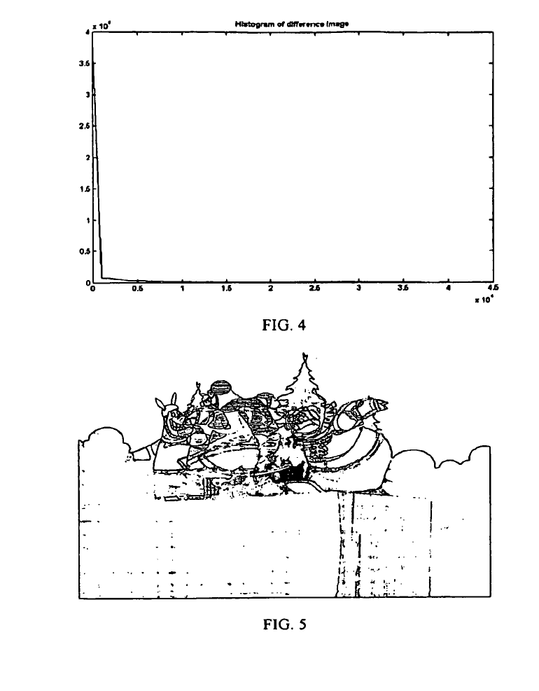

The problem arises when a 30 fps interlaced source is converted into a 30 fps progressive (or non-interlaced) output. In this process the first and second fields for each frame are de-interlaced, yielding 30 non-interlaced frames per second. However, as described above if the 30 fps source was created using 3:2 pulldown, the third frame of the output contains the even lines of one source frame and the odd lines of a different source frame. The result is a frame that contains two half (interlaced) images of any objects that moved between the two frames of the original 24 fps source material. An example of such a frame in the cartoon context is shown in FIG. 5. In this circumstance, you would normally expect to see a frame with the interlace artifact every 5 frames of 30 fps progressive source. The pulldown interlacing artifact is often even more pronounced in cartoon based video than in live action video because the colors and edges of objects or more refined, yielding a striped artifact rather than a more blurred artifact typically seen in live action video.

In one embodiment, de-interlacing is performed by replacing each frame that contains the interlace artifact (every 5 frames) with either the preceding or following frame. In another embodiment, a reverse 3:2 pulldown is performed when converting from a 30 fps interlaced source to a 30 fps progressive output. Alternatively, if the animation is obtained before it is subjected to 3:2 pulldown (in 24 fps format) or in, in which case there will be no interlace artifacts.

Returning to FIG. 1, the encoder includes detecting scene boundaries and segmenting input video into shots 116, calculating the global motion vectors of video sequence 118; synthesizing background for each shot 120; comparing frames with background and extract moving objects 124; and encoding the background and video objects individually 126.

This process improves the compression ratio because the coding area is reduced from the whole frame to small area containing video objects, the background shared by frames only needs to be encoded once, and by using global motion vectors, the bits needed for motion vectors of each macroblock can be reduced.

In the first step 114, the scene boundaries (start and end point of each scene in the video) are detected by segmenting the cartoon sequence into shots. Each shot then is processed and encoded individually. The scene change detection detects visual discontinuities along the time domain. During the process, it is required to extract the visual features that measure the degree of similarity between frames. The measure, denoted as g(n,n+k), is related to the difference between frames n and n+k, where k≧1. Many methods have been proposed to calculate the difference.

In a many embodiments, one or both of two metrics are used to detect scene change: (1) directly calculate the pixelwise norm difference between frames; and (2) calculate the difference between histograms.

$$g ( n , n + k ) = {[ {\sum }_{x , y} {( {I}_{n} ( x , y ) - {I}_{n + k} ( x , y ) )}^{2} ]}^{1 / 2} ,$$

where I(x,y) is the pixel value of the image at x and y position.

There are several types of transitions between video shots. One type of transition is the wipe: e.g., left-to-right, top-down, bottom-up, diagonal, iris round, center to edge, etc. Wipes are usually smooth transitions for both the pixel difference and histogram difference. Another type of transition is the cut. A cut immediately changes to next image, e.g., for making story points using close-up. Cuts typically involve sudden transitions for both pixel difference and histogram difference. Another type of transition is the fade. Fades are often used as metaphors for a complete change of scene. The last type of transition discussed here is the dissolve. In a dissolve, the current image distorts into an unrecognizable form before the next clear image appears, e.g., boxy dissolve, cross dissolve, etc.

In other embodiments, scene change is detected by analyzing the color sets of sequential frames. Scenes in many cartoons use only have a limited number of colors. Color data for sequential frames can be normalized to determine what colors (palette) are used in each frame and a significant change in the color set is a good indicator of a change between scenes.

Turning to scene change detection 118, given two images, their motion transformation can be modeled as

Iₜ(p)=Iₜ₋₁(p−u(p,θ)),

where p is the image coordinates and u(θ) is the displacement vector at p described by the parameter vector θ. The motion transform can be modeled as a simple translational model of two parameters.

The unknown parameters are estimated by minimizing an objective function of the residual error. That is

$${min}_{θ} {\sum }_{i} ρ ( {r}_{i} , σ ) ,$$

where rᵢ is the residual of the i'th image pixel.

rᵢ=Iₜ(pᵢ)−Iₜ₋₁(pᵢ−u(pi,θ)).

Hence, the motion estimation task becomes a minimization problem for computing the parameter vector θ, which can be solved by Gauss-Newton (G-N) algorithm, etc.

Turning to background analysis 120, a static sprite is synthesized for each shot. The static sprite serves as a reference for the frames within a shot to extract the moving objects.

The static sprite generation is composed of three steps: common region detection, background dilation, moving object removal.

The frames of one video shot share one background. The common region can be easily extracted by analyzing the residual sequence. The residual image is calculated by calculating the difference between two adjacent frames. If one pixel is smaller than a pre-determined threshold in every frame of residual sequence, it is deemed as background pixel.

Once the common region is detected, it can be dilated to enlarge the background parts. If one pixel is adjacent to a background pixel and they have similar colors, then it is deemed as background pixel.

For the pixels obscured by moving objects and not dilated from the second step, their colors need to be discovered by eliminating moving objects. To detect moving objects, one frame is subtracted from its next frame.

Turning to color clustering 122, as mentioned before, the number of colors in cartoon is much smaller than that of natural video and a large area is filled with one single color. Therefore, a table, such as a master color list, is established in encoder side to record the major colors, which can be used to recover the original color in decoder side by color mapping.

Turning to object analysis 124, after the background image has been generated, the moving objects are achieved by simply subtracting the frames from the background,

Rₜ(x,y)=Iₜ(x,y)−BG(x,y)

where Iₜ(x,y) is frame t, BG(x,y) is the background, and Rₜ(x,y) is the residual image of frame t. Compared with MPEG-4 content-based coding, an advantage of the present algorithm lies in combining the shape coding and texture coding together.

Assume the pixel value ranges [0, 255]. Then we have

$$\begin{matrix}0 \leq {I}_{t} ( x , y ) \leq 255 \\ 0 \leq BG ( x , y ) \leq 255\end{matrix} \} ⇒ - 255 \leq {R}_{t} ( x , y ) \leq 255.$$

Then the residual image is mapped to [0, 255] in order to make it compatible with video codec.

$${D}_{t} ( x , y ) = round ( \frac{{I}_{t} ( x , y ) + 255}{2} ) ,$$

where round(m) returns the nearest integer towards m. After the conversion, both the background and residual image can be coded by generic codecs. However, the color differs from the original one due to rounding operation, called as color drifting. The artifact can be removed by color mapping, as discussed below with respect to post-processing.

Next, both the backgrounds and objects are encoded using traditional video encoding techniques 126. While this is indicated in FIG. 1 as H.264 encoding, to further improve the visual quality, in some embodiments, a hybrid video coding is used to switch between spatial and frequency domain. For example, for a block to be encoded, general video coding and shape coding are both applied and the one with higher compression ratio will be chosen for actual coding. Consider that the cartoon usually has very clear boundary, the hybrid coding method often produces better visual quality than general video coding method.

More particularly, in H.264 encoding, temporal redundancy is reduced by predictive coding. The coding efficiency of the transform highly depends on the correlation of prediction error. If the prediction error is correlated, the coding efficiency of the transform will be good, otherwise, it will not. In the case of cartoon, it is not uncommon for the prediction error not to be highly correlated for certain objects and/or backgrounds and thus H.264 performs poorly. Accordingly, each block is coded by the most efficient mode, DCT or no transform.

Turning to decoder 110, in general, decoding can be considered as an inverse process of encoding, including scene change synthesis 128, background synthesis 130, color mapping 132, object synthesis 134, H.264 decoder 136, shot concatenation 138, and post-processing 140.

After decoding through functions 128-138, there are often two types of artifacts: color drifting and residual shadow. As mentioned above, color drifting is caused by rounding operation when calculating residual images. It can be easily removed by color mapping. More particularly, using the major color list, as supplied by color mapper 132, post-processing 140 compares colors of the decoded image to the major color list and if the decoded image includes colors that are not on the major color list but close too a color on the major color list and significantly different from any other color on the major color list, the close major color is substituted for the decoded color.

Residual shadow arises from the lossy representation of residual image. As a result, the decoded residual image cannot match the background well, thus artifacts are generated.

The residual shadow can be removed by the following steps in post-processing 140: (1) The residual shadow only happens in the non-background area. Considering that the background of residual image is black it can serve as reference on which part should be filtered. (2) The edge map of the decoded frame is then detected. (3) Edge-preserving low-pass filtering is performed in the decoded frame.

In some embodiments, a further modification of H.264 encoding is used. The modification is based on the observation that human eyes cannot sense any changes below human perception model threshold, due to spatial/temporal sensitivity and masking effects. See e.g., J. Gu, “3D Wavelet-Based Video Codec with Human Perceptual Model”, Master's Thesis, Univ. of Maryland, 1999, which is incorporated by reference as if set forth herein in its entirety. Therefore, the imperceptible information can be removed before transform coding.

The modification utilized three masking effects: (1) Background luminance masking: HVS (Human Visual System) is more sensitive to luminance contrast than to absolute luminance value. (2) Texture masking: The visibility for changes can be reduced by texture and textured regions can hide more error than smooth or edge areas. (3) Temporal masking: Usually bigger inter-frame difference (caused by motion) leads to larger temporal masking.

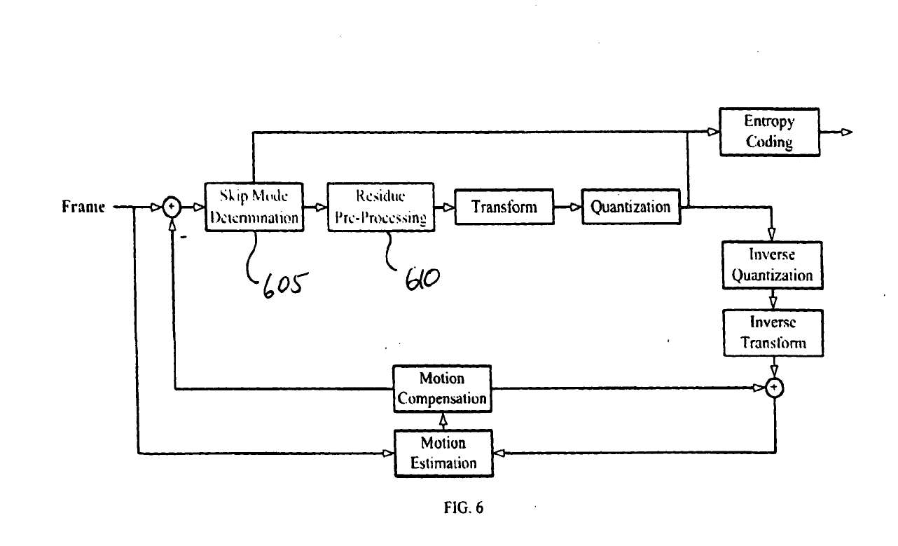

A block diagram of an embodiment of the modified encoder is shown in FIG. 6. The modified encoder integrates two additional modules to the framework of conventional video codec: skip mode determination 605 and residue pre-processing 610. Skip mode determination module expands the range of skip mode. Residue pre-processing module removes imperceptible information to improve coding gain, while not damaging subjective visual quality.

To remove perceptually insignificant components from video signals, the concept of JND profile See, e.g. X. Yang et al., “Motion-Compensated Residue Preprocessing in Video Coding Based on Just-Noticeable-Distortion Profile”, IEEE Trans on Circuits and Systems for Video Tech., vol. 15, no. 6, pp 742-752, June 2005, which is incorporated by reference as if set forth herein in its entirety, N. Jayant, J. Johnston and R. Safranek, “Signal compression based on models of human perception”, Proc. IEEE, vol. 81, pp 1385-1422, October 1993, which is incorporated by reference as if set forth herein in its entirety. has been successfully applied to perceptual coding of video and image. JND provides each signal to be coded with a visibility threshold of distortion, below which reconstruction errors are rendered imperceptible.

In this section, the spatial part of JND is first calculated within frame. Spatial-temporal part is then obtained by integrating temporal masking.

At the first step, there are primarily two factors affecting spatial luminance JND in image domain: background luminance masking and texture masking. The spatial JND of each pixel can be described in the following equation

JNDₛ(x,y)=f₁(bg(x,y))+f₂(mg(x,y))−C_{b,m}·min{f₁(bg(x,y)),f₂(mg(x,y))},

for 0≦x<H, 0≦y<W,

where f₁ represents the error visibility thresholds due to texture masking, f₂ is the visibility threshold due to average background luminance. C_{b,m}(0<C_{b,m}<1) accounts for the overlapping effect of masking. H and W denote the height and width of the image, respectively. mg(x,y) denotes the maximal weighted average of luminance gradients around the pixel at (x,y) and bg(x,y) is the average background luminance.

$${f}_{1} ( bg ( x , y ) , mg ( x , y ) ) = mg ( x , y ) α ( bg ( x , y ) ) + β ( bg ( x , y ) ) \\ {f}_{2} ( bg ( x , y ) ) = \{ \begin{matrix}{T}_{0} \cdot ( 1 - {( bg ( x , y ) / 127 )}^{1 / 2} ) + 3 & bg ( x , y ) \leq 127 \\ γ \cdot ( bg ( x , y ) - 127 ) + 3 & bg ( x , y ) > 127\end{matrix} \\ α ( bg ( x , y ) ) = bg ( x , y ) \cdot 0.0001 + 0.115 \\ β ( bg ( x , y ) ) = λ - bg ( x , y ) \cdot 0.01 , for 0 \leq x < H , \\ 0 \leq y < W ,$$

where T0, γ and λ are found to be 17, 3/128 and ½ through experiments. See, e.g., C. H. Chou and Y. C. Li, “A perceptually tuned subband image coder based on the measure of just-noticeable-distortion profile”, IEEE Circuits and Systems for Video Tech., vol. 5, pp 467-4′76, December 1995, which is incorporated by reference as if set forth herein in its entirety.

The value of mg(x,y) across the pixel at (x,y) is determined by calculating the weighted average of luminance changes around the pixel in four directions. To avoid over-estimation of masking effect around the edge, the distinction of edge regions is taken into account. Therefore, mg(x,y) is calculated as

$$mg ( x , y ) = η \cdot we ( x , y ) \cdot max \{ \vert {{grad}_{k}}_{k = 1 , 2 , 3 , 4} ( x , y ) \vert \}$$

$${grad}_{k} ( x , y ) = \frac{1}{16} {\sum }_{i = 1}^{5} {\sum }_{j = 1}^{5} p ( x - 3 + i , y - 3 + j ) \cdot {G}_{k} ( i , j ) ,$$

where p(x,y) denotes the pixel at (x,y).

The four operators Gk(i,j) are:

$${G}_{1} = [ \begin{matrix}0 & 0 & 0 & 0 & 0 \\ 1 & 3 & 8 & 3 & 1 \\ 0 & 0 & 0 & 0 & 0 \\ - 1 & - 3 & - 8 & - 3 & - 1 \\ 0 & 0 & 0 & 0 & 0\end{matrix} ] , \\ {G}_{2} = [ \begin{matrix}0 & 0 & 1 & 0 & 0 \\ 0 & 8 & 3 & 0 & 0 \\ 1 & 3 & 0 & - 1 & - 3 \\ 0 & 0 & - 3 & - 8 & 0 \\ 0 & 0 & - 1 & 0 & 0\end{matrix} ] , \\ {G}_{3} = [ \begin{matrix}0 & 0 & 1 & 0 & 0 \\ 0 & 0 & 3 & 8 & 0 \\ - 1 & - 3 & 3 & 0 & 1 \\ 0 & - 8 & - 3 & 0 & 0 \\ 0 & 0 & - 1 & 0 & 0\end{matrix} ] , \\ {G}_{4} = [ \begin{matrix}0 & 1 & 0 & - 1 & 0 \\ 0 & 3 & 0 & - 3 & 0 \\ 0 & 8 & 0 & - 8 & 0 \\ 0 & 3 & 0 & - 3 & 0 \\ 0 & 1 & 0 & - 1 & 0\end{matrix} ] .$$

we(x,y) is an edge-related weight of the pixel at (x,y). Its corresponding matrix we is computed by edge detection followed with a Gaussian lowpass filter.
we=e [symbol] h, where e is the edge map of the original video frame, with element values of 0.1 for edge pixels and 1 for nonedge pixels. h is a k×k Gaussian lowpass filter.

The average background luminance, bg(x,y), is calculated by a weighted lowpass operator, B(i,j), i,j=1, . . . , 5.

$$bg ( x , y ) = \frac{1}{32} {\sum }_{i = 1}^{5} {\sum }_{j = 1}^{5} p ( x - 3 + i , y - 3 + j ) \cdot B ( i , j ) , \\ where B = [ \begin{matrix}1 & 1 & 1 & 1 & 1 \\ 1 & 2 & 2 & 2 & 1 \\ 1 & 2 & 0 & 2 & 1 \\ 1 & 2 & 2 & 2 & 1 \\ 1 & 1 & 1 & 1 & 1\end{matrix} ] .$$

At the second step of JND model generation, the JND profile representing the error visibility threshold in the spatial-temporal domain is expressed as

JND(x,y,n)=f₃(ild(x,y,n))·JND_{S}(x,y,n),

where ild(x,y,n) denotes the average interframe luminance difference between the nth and (n−1)th frame.

ild(x,y,n)=[p(x,y,n)−p(x,y,n−1)+bg(x,y,n)−bg(x,y,n−1)]/2.

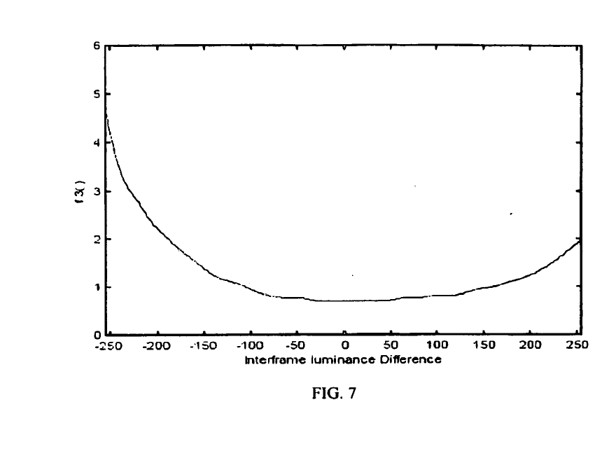

f₃ represents the error visibility threshold due to motion. The empirical results of measuring f₃ for all possible inter-frame luminance differences are shown in FIG. 7.

In H.264, a macro-block is skipped if and only if it meets the following conditions all together (See, e.g., Advanced video coding for generic audiovisual services (H.264), ITU-T, March, 2005, which is incorporated by reference as if set forth herein in its entirety.):

The best motion compensation block size is 16×16;

Reference frame is just previous one;

Motion vector is (0,0) or the same as its PMV (Predicted Motion Vector); and

Its transform coefficients are all quantized to zero.

In fact, the above conditions are over strict for cartoon content. Even if the transform coefficients are not quantized to zero, the macro-block can still be skipped as long as the distortion is imperceptible.

Therefore, based on the basic concept of JND profile, in the modified encoder, in skip mode determination 605, the criteria to determine if a macro-block can be skipped. The minimally noticeable distortion (MND) of a macro-block can be expressed as

$$MND ( i , j ) = {\sum }_{x = 0}^{15} {\sum }_{y = 0}^{15} {JND}^{2} ( x , y ) \cdot δ ( i , j )$$

where δ(i,j) is the distortion index at point (x,y), ranging from 1.0 to 4.0.

The mean square error (MSE) after motion estimation can be calculated as

$$MSE ( i , j ) = {\sum }_{x = 0}^{15} {\sum }_{y = 0}^{15} {[ p ( x , y ) - {p}^{′} ( x , y ) ]}^{2} ,$$

where p(x,y) denotes the pixel at (x,y) of original frame and p′(x,y) is predicted pixel. If MSE(i,j)<MND(i,j), the motion estimation distortion is imperceptible and the macro-block can be obtained by simply copying its reference block.

A byproduct is that the computational cost is reduced, since transform coding is not needed for a skipped macro-block.

The purpose of residue pre-processing 610 is to remove perceptually unimportant information before actual coding. The JND-adaptive residue preprocessor can be expressed as

$$\hat{R} ( x , y ) = \{ \begin{matrix}R ( x , y ) + λ \cdot JND ( x , y ) & R ( x , y ) - {\overline{R}}_{B} < - λ \cdot JND ( x , y ) \\ {\overline{R}}_{B} & \vert R ( x , y ) - {\overline{R}}_{B} \vert \leq λ \cdot JND ( x , y ) \\ R ( x , y ) - λ \cdot JND ( x , y ) & R ( x , y ) - {\overline{R}}_{B} > λ \cdot JND ( x , y ) ,\end{matrix}$$

where R̅_{B} is the average of residue in the block (the block size depends upon transform coding) around (x,y). λ(0<λ<1) is used to avoid introducing perceptual distortion to motion compensated residues.

1. A system for encoding a video sequence, the system specialized for encoding video of animated or cartoon content, the system comprising:
a background analyzer that removes moving objects from a series of video frames and generates a background definition for a static background used in a plurality of sequential video frames;
a color clusterer that analyzes the colors contained in a video stream and creates a major color list of colors occurring in the video stream;
an object identifier that identifies one or more objects that are constant within a series of video frames except for their position and rotational orientation within the series of video frames; and
a hybrid encoder that encodes backgrounds and objects derived from a video sequence according to one of a plurality of encoding techniques depending on the compression achieved by each of the plurality of encoding techniques.

2. A method of encoding a video sequence, the method specialized for encoding video of animated or cartoon content, the method comprising:
removing moving objects from a series of video frames and generates a background definition for a static background used in a plurality of sequential video frames;
analyzing the colors contained in a video stream and creates a major color list of colors occurring in the video stream;
identifying one or more objects that are constant within a series of video frames except for their position and rotational orientation within the series of video frames; and
encoding backgrounds and objects derived from a video sequence according to one of a plurality of encoding techniques depending on the compression achieved by each of the plurality of encoding techniques.

3. The system of claim 1, further comprising:
an inter video frame pre-processor that reduces noise in a video frame by removing slight differences in color within areas of the video frame with only slight differences in color.

4. The system of claim 1, further comprising
an intra video frame pre-processor that reduces noise in consecutive video frames by removing slight differences in color within the same portions of the consecutive video frames with only slight differences in color.

5. The system of claim 1, wherein the hybrid encoder is adapted to skip transform encoding of a macro-block that has a motion estimation distortion that is below a minimally noticeable distortion for the macro-block.

6. The system of claim 1, wherein the hybrid encoder further comprises
a residue pre-processor that identifies Just-Noticeable-Distortion (JND) residue in a block of video frame and removes the identified JND residue before the block is encoded.

7. The system of claim 1, wherein the plurality of encoding techniques comprises DCT encoding and non-transform encoding.

8. The system of claim 7, wherein the compression achieved by each of the plurality of encoding techniques is determined using the correlation of prediction error of each of the plurality of encoding techniques.

9. The method of claim 2, further comprising:
pre-processing video frames to reduce noise by removing slight differences in color within areas of a video frame with only slight differences in color.

10. The method of claim 2, further comprising
pre-processing video frames to reduce noise by removing slight differences in color within the same portions of consecutive video frames with only slight differences in color.

11. The method of claim 2, wherein encoding backgrounds and objects further comprises
skipping transform encoding of a macro-block that has a motion estimation distortion that is below a minimally noticeable distortion for the macro-block.

12. The method of claim 2, wherein encoding backgrounds and objects further comprises
identifying Just-Noticeable-Distortion (JND) residue in a block of video frame and removing the identified JND residue before the block is encoded.

13. The method of claim 2, wherein the plurality of encoding techniques comprises DCT encoding and non-transform encoding.

14. The method of claim 13, wherein the compression achieved by each of the plurality of encoding techniques is determined using the correlation of prediction error of each of the plurality of encoding techniques.
